(19) United States
(12) Patent Application Publication
(10) Pub. No.: US 2019/0180475 A1
(43) Pub. Date: Jun. 13, 2019

(54) DYNAMIC CAMERA CALIBRATION

(71) Applicant: QUALCOMM Incorporated, San Diego, CA (US)

(72) Inventors: James Wilson Nash, San Diego, CA (US); Kalin Mitkov Atanassov, San Diego, CA (US); Albrecht Johannes Lindner, La Jolla, CA (US); Justin Cheng, San Diego, CA (US)

(21) Appl. No.: 15/835,693

(22) Filed: Dec. 8, 2017

(51) Int. Cl. G06T 7/80; G06T 7/55; G06T 7/00

(52) U.S. Cl. CPC G06T 7/80; G06T 2207/10004; G06T 7/97; G06T 7/55

(57) ABSTRACT

Client calibration can include: (a) instructing a host to display a first desired target, (b) imaging the first displayed target, (c) determining a second desired target based on the imaging, (d) instructing the host to display a second desired target, and (e) adjusting a calibration parameter based on one or more images of the second desired target. The second desired target can be determined (e.g., selected, dynamically generated) based on the first desired target.

### CROSS-REFERENCE TO RELATED APPLICATIONS

None.

### STATEMENT ON FEDERALLY SPONSORED RESEARCH OR DEVELOPMENT

None.

### BACKGROUND

### Field of the Disclosure

The present disclosure relates to camera calibration.

### Description of Related Art

Mobile devices typically include a camera. To be effective, the camera may require intrinsic and extrinsic calibration. The mobile device manufacturer originally calibrates the camera. Over time, some parameters of the original calibration can become obsolete. The camera now needs to be recalibrated. Prior art recalibration techniques typically involve the mobile device imaging a single target. The target is often printed onto a sheet of paper.

### SUMMARY

A calibration method can include, via a client comprising one or more client processors: determining a first desired target; instructing a host comprising one or more host processors and a host display to present the first desired target on the host display; imaging the first displayed target to obtain one or more first images of the first displayed target; and assessing the one or more first images of the first displayed target.

The method can further include: determining a second desired target based on the assessment of the first images; instructing the host to present the second desired target on the host display; imaging the second displayed target to obtain one or more second images of the second displayed target; and adjusting a calibration parameter based on the one or more second images of the second displayed target and the second desired target.

A client processing system can include one or more client processors configured to: determine a first desired target; instruct a host including one or more host processors and a host display to present the first desired target on the host display; image the first displayed target to obtain one or more first images of the first displayed target; and assess the one or more first images of the first displayed target.

The one or more client processors can be configured to: determine a second desired target based on the assessment of the first images; instruct the host to present the second desired target on the host display; image the second displayed target to obtain one or more second images of the second displayed target; and adjust a calibration parameter based on the one or more second images of the second displayed target and the second desired target.

A non-transitory computer readable medium can include program code, which, when executed by one or more client processors, causes the one or more client processors to perform operations. The program code can include code for: determining a first desired target; instructing a host comprising one or more host processors and a host display to present the first desired target on the host display; imaging the first displayed target to obtain one or more first images of the first displayed target; and assessing the one or more first images of the first displayed target.

The program code can include code for: determining a second desired target based on the assessment of the first images; instructing the host to present the second desired target on the host display; imaging the second displayed target to obtain one or more second images of the second displayed target; and adjusting a calibration parameter based on the one or more second images of the second displayed target and the second desired target.

A client processing system can include: (a) means for determining a first desired target; (b) means for instructing a host including one or more host processors and a host display to present the first desired target on the host display; (c) means for imaging the first displayed target to obtain one or more first images of the first displayed target; (d) means for assessing the one or more first images of the first displayed target; (e) means for determining a second desired target based on the assessment of the first images; (f) means for instructing the host to present the second desired target on the host display; (g) means for imaging the second displayed target to obtain one or more second images of the second displayed target; and (h) means for adjusting a calibration parameter based on the one or more second images of the second displayed target and the second desired target.

### BRIEF DESCRIPTION OF DRAWINGS

For clarity and ease of reading, some Figures omit views of certain features. Unless stated otherwise, the Figures are not to scale and features are shown schematically.

FIG. 1 shows an example client imaging an example host.

FIG. 1A shows an example rear surface of the client.

FIG. 2 shows an example image sensor package.

FIG. 2A shows a fragmentary cross sectional elevational view of an example sensor panel of the image sensor package.

FIG. 2B shows a fragmentary top plan view of the sensor panel.

FIG. 2C shows a fragmentary and expanded cross sectional elevational view of an example pixel of the sensor panel.

FIG. 3 shows a scene illuminated with dots emitted by an example projector. FIG. 3 can be representative of a textured depth map of the scene.

FIG. 3A is a view from a camera configured to capture the dots, but not the scene texture.

FIG. 3B is a view from a camera configured to capture the scene texture, but not the dots.

FIG. 3C shows a partially assembled texture depth map.

FIG. 4 shows intrinsic and extrinsic calibration parameters of the client.

FIG. 4A shows extrinsic calibration parameters of the client.

FIG. 5 shows an example target.

FIG. 5A shows various states of the target.

FIG. 6 is a block diagram of an example calibration routine.

FIG. 7 shows an example target with a first spatial pattern, a low spatial complexity, and a low color complexity.

FIG. 7A shows an example target with the first spatial pattern and a medium spatial complexity.

FIG. 7B shows an example target with the first spatial pattern and a high spatial complexity.

FIG. 8 shows an example target with the first spatial pattern, the low spatial complexity, and a medium color complexity.

FIG. 8A shows an example target with the first spatial pattern, the low spatial complexity, and a medium color complexity different than the medium color complexity of FIG. 8.

FIGS. 9-9D show example targets.

FIG. 10 shows the target of FIG. 7 illuminated with dots.

FIG. 10A shows an example target illuminated with dots.

FIG. 11 shows an example processing system for the client and the host.

### DETAILED DESCRIPTION

The present application discloses example implementations of the claimed inventions. The claimed inventions are not limited to the disclosed examples. Therefore, some implementations of the claimed inventions will have different features than in the example implementations. Changes can be made to the claimed inventions without departing from the claimed inventions' spirit. The claims are intended to cover implementations with such changes.

At times, the present application uses relative terms (e.g., front, back, top, bottom, left, right, etc.) to give the reader context when viewing the Figures. Relative terms do not limit the claims. Any relative term can be replaced with a numbered term (e.g., left can be replaced with first, right can be replaced with second, and so on).

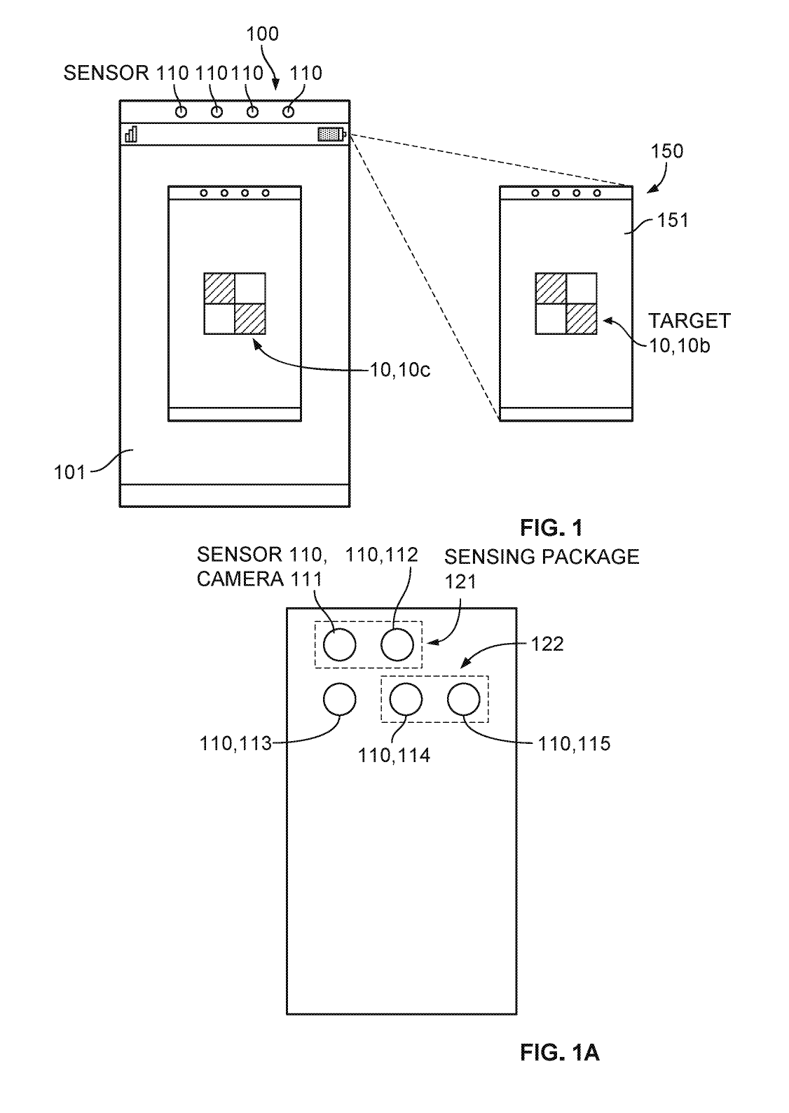

FIG. 1 shows an example client 100 imaging an example host 150. FIG. 1A shows an example rear face of client 100. Client 100 can include a display 101 and a plurality of sensors 110. Host 150 can include a display 151. Client 100 can be configured to recalibrate sensors 110 based on one or more calibration targets 10 (also called targets). Client 100 can instruct host 150 to display a series of different targets 10 until client 100 is able to recalibrate. The terms calibrate and recalibrate are used synonymously.

Client 100 can be a mobile device (e.g., a smartphone, a dedicated camera assembly, a tablet, a laptop, and the like). Client 100 can be any system with one or more sensors in need of calibration, such as a vehicle. Host 150 can be a mobile device (e.g., a smartphone, a tablet, a laptop, and the like). Host 150 can be any device with a display 151, such as a mobile device, a standing computer monitor, a television, and the like. If host 150 is a projector, then the host display 151 can be the screen onto which host 150 projects. Client 100 and host 150 can each include a processing system 1100. Client 100 and/or host 150 can be configured to perform each and every operation (e.g., function) disclosed herein.

Sensors 110 can include a first camera 111, a second camera 112, a third camera 113, a fourth camera 114, and a projector 115. Cameras 111-114 are also called image sensor packages. Projector 115 is also called an emitter or a laser array.

First, second, and third cameras 113 can be full-color cameras configured to capture full-color images of a scene. Fourth camera 114 can be configured to capture light produced by projector 115. When projector 115 is configured to output an array of infrared lasers, fourth camera 114 can be an infrared camera.

First and second cameras 111, 112 can be aspects of a first depth sensing package 121 (also called a first rangefinder). Client 100 can apply images (e.g., full color images, infrared images, etc.) captured by first and second cameras 111, 112 to construct a first depth map of a scene.

Fourth camera 114 and projector 115 can be aspects of a second depth sensing package 122 (also called a second rangefinder). Projector 115 can emit a light array toward a scene. The light array can include a plurality of discrete light beams (e.g., lasers). The aggregated light array can have a cone or a pyramid geometry when projected into space.

Each light beam can form a dot on an object in the scene. Fourth camera 114 can capture an image of the dots (a fourth image). Client 100 can derive a second depth map based on the fourth image. According to some examples, projector 115 is configured to emit an infrared light array and fourth camera 114 is configured to capture the corresponding infrared dots.

Third camera 113 can be a high resolution full-color camera. Third camera 113 can be used to map texture (e.g., color) of a scene onto the first depth map and/or the second depth map. First camera 111 and/or second camera 112 can be used for the same texture mapping purpose. Any of first, second, third, and fourth cameras 111-114 can be used to capture full-color images of a scene. Any of first, second, third, and fourth cameras 111-114 can be used to capture non-full color images of a scene (e.g., infrared images of a scene).

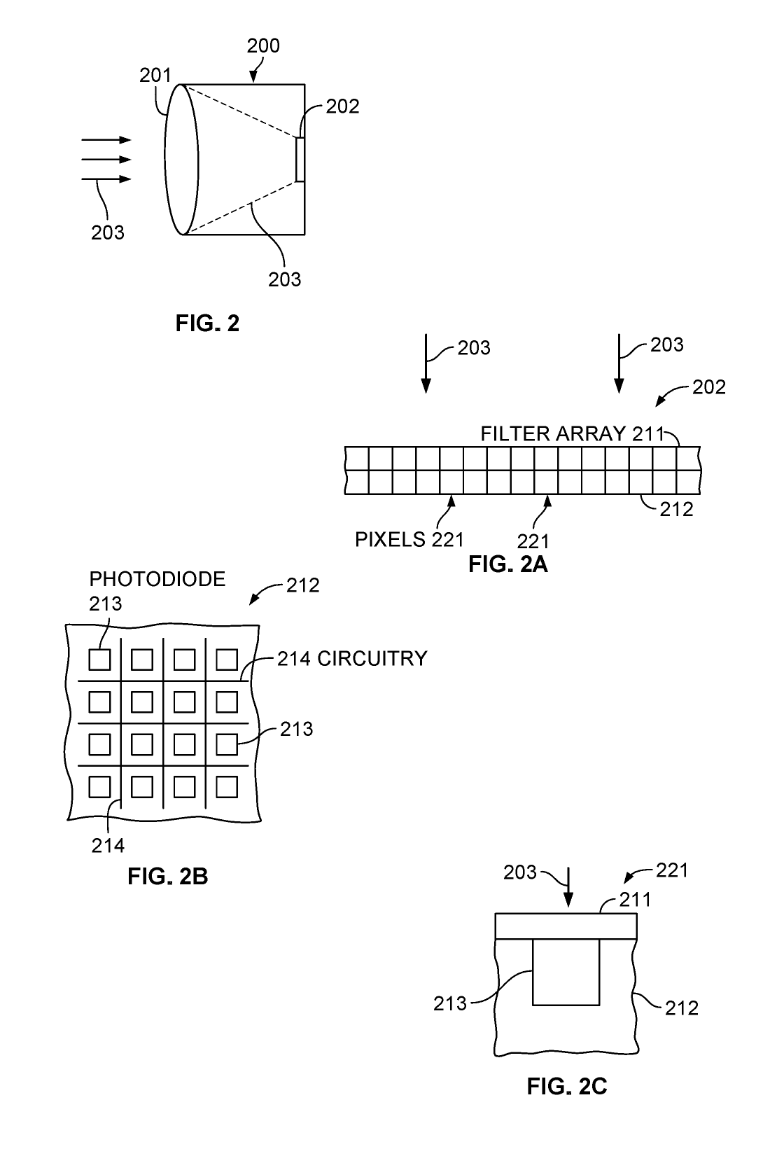

FIG. 2 shows an image sensor package 200, which can be representative of first, second, third, and fourth cameras 111-114. Package 200 can include a lens 201 and a sensor panel 202 (also called a board). Scene light 203 can flow through lens 201 toward sensor panel 202. Light 203 can pass through one or more additional optical components between lens 201 and panel 202 (e.g., one or more additional lenses, one or more mirrors, one or more apertures, one or more prisms, and the like.).

Referring to FIGS. 2A and 2B, sensor panel 202 can include a filter array 211 and a silicon layer 212. Silicon layer 212 can include a plurality (e.g., millions) of photodiodes 213 and associated circuitry 214. The design of filter array 211 can change depending on the type of camera. For example, first, second, and third cameras 111-113 can each have a Bayer or Quadra filter array, while fourth camera 114 can have an infrared filter array (e.g., a Bayer with IR filter array, an array consisting of infrared filters, etc.).

Referring to FIGS. 2A and 2C, sensor panel 202 can include a plurality of sensor pixels 221. Each sensor pixel 221 can be defined by at least photodiode 213 and a corresponding filter from array 211. Sensor panel 202 can include additional un-shown layers such as a microlens layer, a spacer layer, and the like.

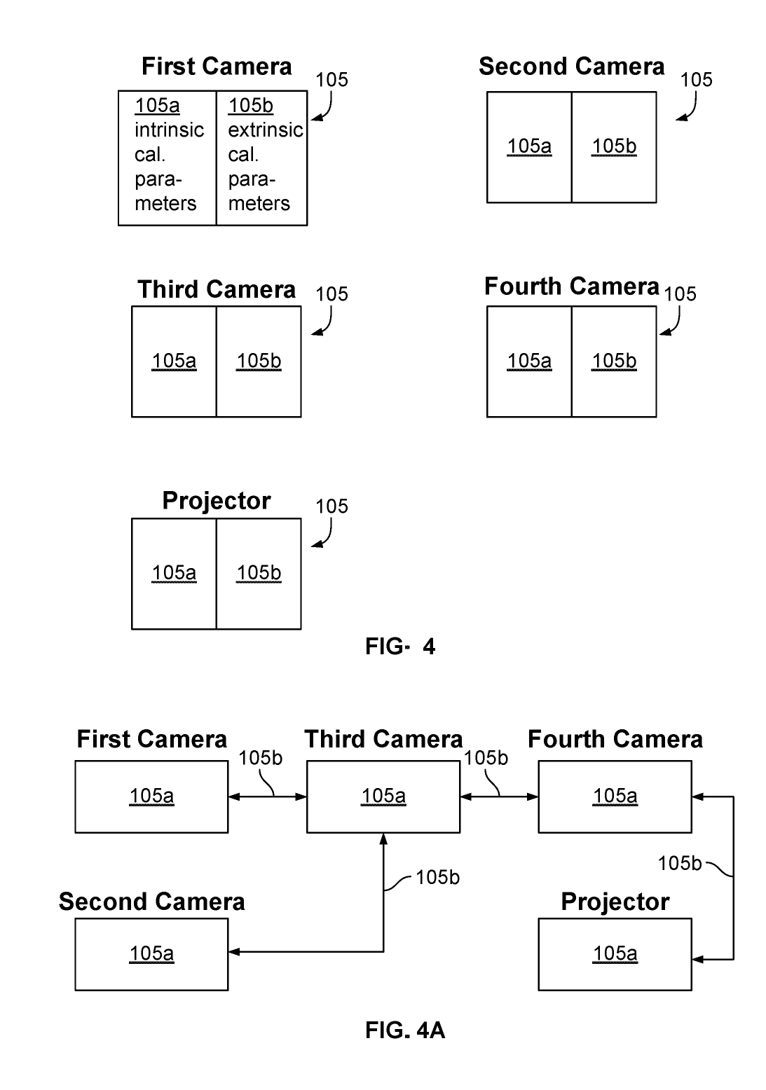

Referring to FIG. 4, client 100 can store calibration parameters 105 (also called parameters) for sensors 110. Parameters 105 can include intrinsic calibration parameters 105a (also called intrinsic parameters) and extrinsic calibration parameters 105b (also called extrinsic parameters). Parameters 105 can be spatial or photometric.

Extrinsic parameters 105b can relate distinct 3D coordinate systems. For example, extrinsic parameters 105b can relate the coordinate system of a scene with the coordinate system of a camera. As another example, extrinsic parameters 105b can relate the coordinate system of a first camera with the coordinate system of a second camera. Extrinsic parameters 105b can thus include a three-degree-of-freedom translation component (also called offset) and a three-degree-of-freedom rotation component (i.e., yaw, pitch, and roll).

Intrinsic parameters 105a can relate a 3D coordinate system of a camera to the 2D coordinate system of an image that the camera captures. Thus, intrinsic parameters can describe how an object in the 3D coordinate system of a camera will project to the 2D coordinate system of the photosensitive face of sensor panel 202. Intrinsic parameters 105a can include a translation component, a scaling component, and a shear component. Examples of these components can include camera focal length, image center (also called principal point offset), skew coefficient, and lens distortion parameters.

Intrinsic and/or extrinsic parameters 105a, 105b can further include photometric calibration parameters to correct for color (e.g., chromatic dispersion). A photometric intrinsic parameter can determine the gain applied to each sensor pixel reading. For example, client 100 can apply a gain to analog photometrics captured by each sensor pixel 221 of a given image sensor package 200. The gain for each sensor pixel 221 can be different. The collection of gains can be one aspect of an intrinsic calibration parameter 105a.

Client 100 can store a set of intrinsic calibration parameters 105a for each camera 111-114 and projector 115. Client 100 can apply intrinsic calibration parameters when capturing a digital measurement (e.g., an image) of a scene.

Client 100 can store a set of extrinsic parameters 105b for each possible combination two or more sensors 105. Client 100 can apply extrinsic parameters 105b to relate measurements of a scene (e.g., an image or a depth map) captured by discrete sensors 105.

Client 100 can store a first set of extrinsic parameters 105b spatially relating (e.g., spatially mapping) first images captured by first camera 111 to second images captured by second camera 112. Client 100 can reference the first set of calibration parameters when building the first depth map based on the first and second images.

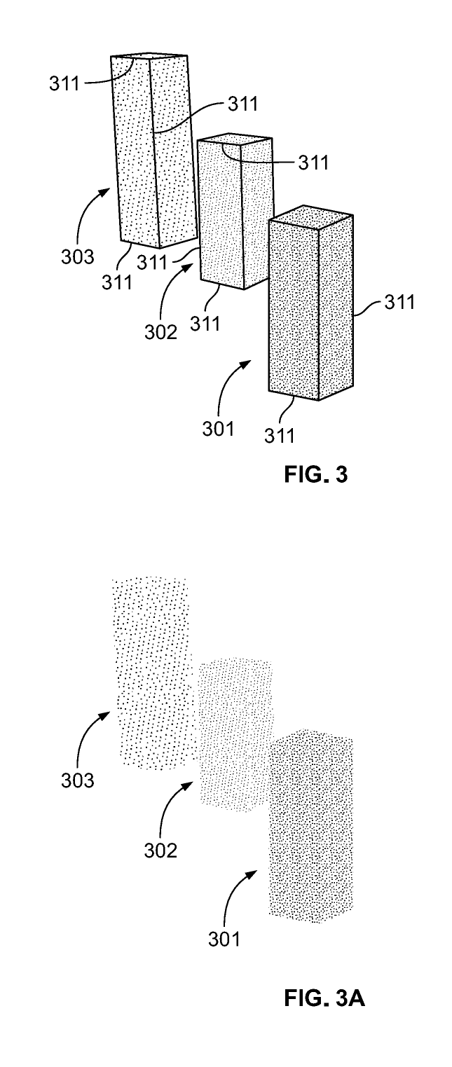

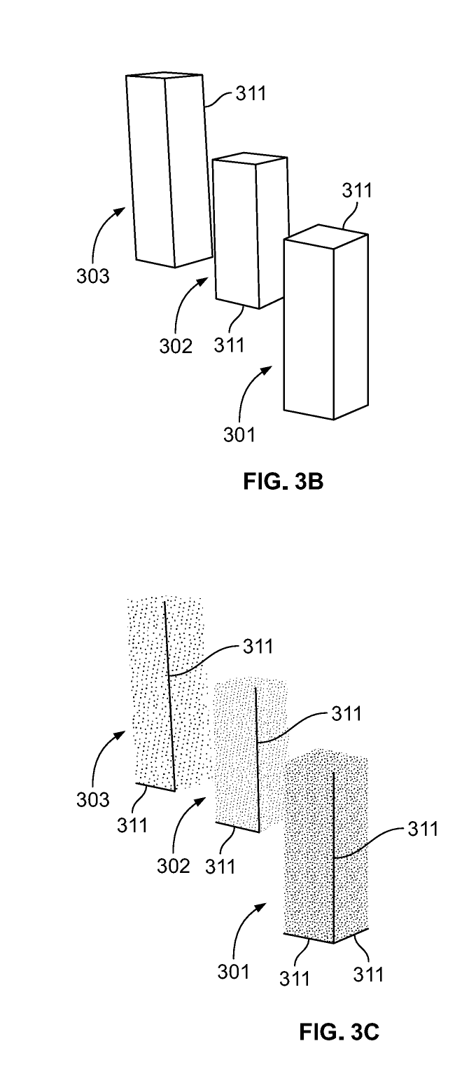

Client 100 can store a second set of extrinsic parameters 105b relating light emitted by projector 115 to dots captured by fourth camera 114. The second set of extrinsic calibration parameters 105b can instruct client 100 to assign a certain depth to a scene region based on the density of dots on the scene region captured by fourth camera 114. An example technique for building a second depth map is discussed below with reference to FIGS. 3-3C.

FIG. 3 shows objects 301-303, which projector 115 has illuminated with infrared dots. First object 301 has a high dot density. Second object 302 has a medium dot density. Third object 303 has a low dot density. Each object 301-303 includes edges 311 and color (not shown).

FIG. 3A shows an image of objects 301-303, which fourth camera 114 has captured. Fourth camera 114 may be unable to resolve the edges 311 and colors of objects 301-303. Instead, fourth camera 114 has captured the infrared dots projected onto objects 301-303.

Client 100 can recognize the depths of objects 301-303 based on (a) the captured dot densities, (b) intrinsic calibration of fourth camera 114 (c) extrinsic calibration between projector 115 and fourth camera 114. Client 100 may further apply (d) intrinsic calibration of projector 115. FIG. 3A can be a visual representation of a second depth map of objects 301-303.

FIG. 3B represents a full-color image of object 300 (colors are omitted, but edges 311 are shown). To build a textured depth map of objects 301-303, client 100 can cross reference the second depth map with a third image of objects 301-303 from third camera 113. Client 100 can apply the well-defined edges 311 visible in the full-color image to the second depth map, resulting in a textured depth map. The textured depth map can be similar to the view shown in FIG. 3 (although color is omitted). A textured depth map can include discrete files spatially mapped together such as a depth map of a scene spatially mapped to a full-color image of the scene.

Client 100 can store a third set of extrinsic parameters 105b spatially relating (e.g., spatially mapping) third images captured by third camera 113 to fourth images captured by fourth camera 114. Client 100 can apply the third set of extrinsic calibration parameters to apply texture (e.g., color) extracted from the third images to the fourth images and/or the depth map constructed with the fourth images.

Similarly, client 100 can store a fourth set of extrinsic parameters 105b spatially relating the first images, second images, and/or or first depth maps (derived from first and/or second cameras 111, 112) to the third images (derived from third camera 113).

FIG. 4A shows extrinsic calibration parameters 105b for spatially mapping third images to (a) first images, (b) second images, (c) fourth images, (d) first depth maps, and (e) second depth maps. The extrinsic parameters 105b of FIG. 4A can represent the above-discussed third and fourth sets.

Client 100 can store a fifth set of extrinsic parameters 105b spatially relating the first and/or second images to the fourth images. The fifth set of extrinsic calibration parameters can spatially relate the first depth maps to the second depth maps.

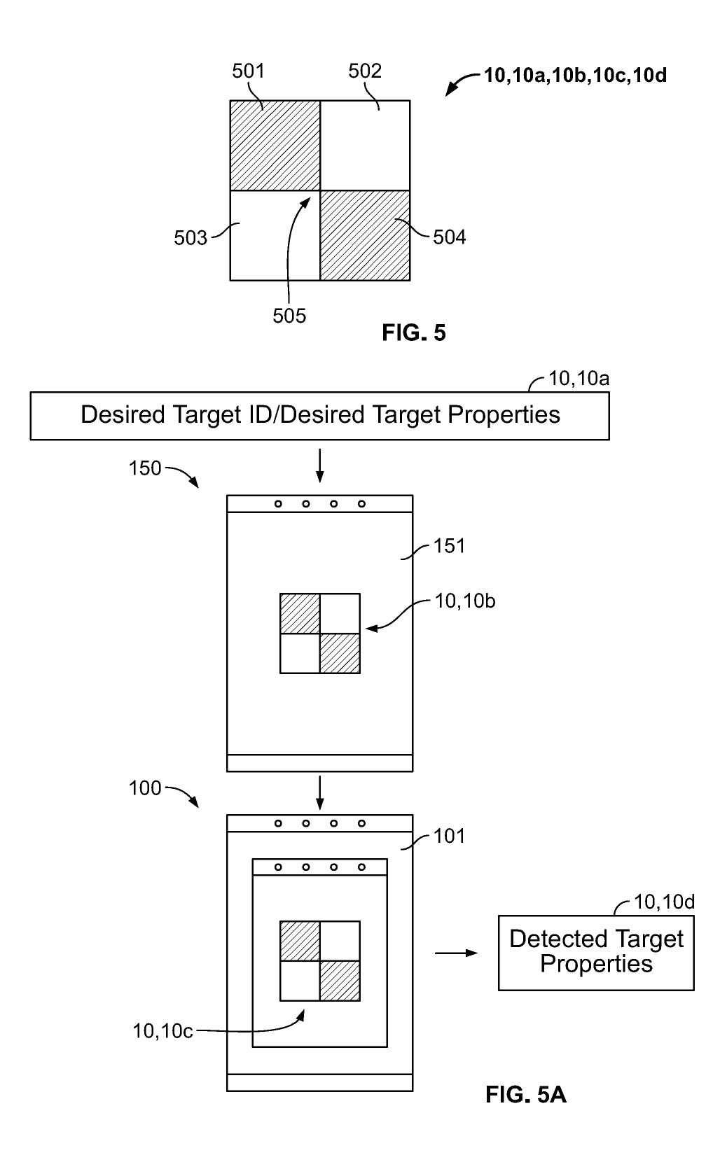

Referring to FIG. 5, a calibration target (i.e., a target) 10 can be defined by target properties including a spatial arrangement, a color scheme, and an absolute geometry. The target properties can define features. In FIG. 5, target 10 can have two-dimensional spatial features (e.g., minor boxes 501-504), one-dimensional spatial features (e.g., the edges of minor boxes 501-504), and zero-dimensional spatial features (e.g., intersection point 505, an outside corner of a minor box 501). Spatial features can have color features and absolute geometry features.

Spatial arrangement can refer to the geometry of target 10 in terms of relative size. In FIG. 5, target 10 has a spatial arrangement of a primary square 500 divided into four minor squares (minor boxes) 501-504. The spatial arrangement of target 10 can be captured/stored in a variety of ways. For example, as a vector file including coordinates of a series of line segments representing the edges (not labeled) shown in FIG. 5.

Color scheme can refer to a color assigned to each two-dimensional feature object. In FIG. 5, minor boxes 501 and 504 are hatched to indicate a first color (e.g., black) while minor boxes 502 and 503 are unhatched to indicate a second color (e.g., white).

Absolute geometry can refer to the dimensions of target 10 in object space (also called scene space). Examples of absolute geometry can include physical length, physical width, physical area, physical curvature etc. Some states of a target 10 (states are discussed below) can lack absolute geometry.

Absolute geometry can be expressed in a variety of forms. For example, the two dimensional area of target 10 can be expressed in the total number of pixels devoted to target 10 if the size of each pixel is known (e.g., [total number of pixels in a display]/[surface area of the display]). Absolute geometry can be a transform converting relative sizes in the spatial arrangement into absolute dimensions (e.g., centimeters).

Referring to FIGS. 5 and 5A, a target 10 and individual features thereof, can exist in a plurality of states (also called formats) including a desired state, a displayed state, an imaged state, and a converted state.

Desired target 10a (i.e., target 10 in a desired state) can be an electronic file listing desired properties of target 10. Desired target 10a can include a vectorized spatial arrangement and color scheme of target 10. Desired target 10a can be a raster file (e.g., a JPEG). Desired target 10a can be an ID (e.g., target no. 1443). Desired target 10a can include metadata listing certain features (e.g., total number of feature points, coordinates of each feature point).

Desired target 10a does not require an absolute geometry and can be expressed in terms of a relative coordinate system (e.g., main box 500 has area 4x², and each sub-box has area x², where x is a function of the static properties (e.g., surface area and resolution) of host display 151.

To acquire absolute geometry, desired target 10a can be appended with the properties of host display 151 (e.g., surface area per pixel, curvature, surface area, intrinsic calibration). Host display properties can include static properties and variable properties. Static properties can include inherent limitations of host display 151, such as surface area, curvature, number of pixels, pixel shape, and the like. Variable properties can include calibration of host display, including user-selected brightness, user-selected contrast, user-selected color temperature, and the like.

A desired target 10a appended with absolute geometry of host display 151 is called a settled desired target 10a. For example, desired target 10a can initially include a perfect circle in its non-settled or pure state. But host display 151 may be incapable of displaying a perfect circle since each host display pixel can be rectangular. Based on pixel geometry, pixel density, and the like, client 100 can deform the perfect circle of desired target 10a into an imperfect circle (e.g., a circle formed as a plurality of rectangular boxes). Based on the deformation, client 100 can revise the quantity or geometry of features (e.g., feature points, feature surfaces) in desired target 10a such that desired target 10a occupies a settled state.

Displayed target 10b (i.e., target 10 in a displayed state) can be target 10 as presented on host display 151. Displayed target 10b has absolute geometry, even if desired target 10a only includes relative geometry.

Imaged target 10c (i.e., target 10 in an image state) can be an image of displayed target 10b captured by client sensors 110. Imaged target 10c can be a single image of displayed target 10b. Imaged target 10c can be an image derived from a plurality of individual images of displayed target 10b. For example, imaged target 10c can be the average of two separate images.

Imaged target 10c can include pre-processing and post-processing where client 100 can apply intrinsic parameters 105a to source data that sensors 110 captured. Imaged target 10c can be a full-color image stored in a compressed form (e.g., a JPEG) or an uncompressed form. Imaged target 10c may not be a perfect copy of displayed target 10b due to client miscalibration.

A converted target 10d (i.e., target 10 in a converted state) can be some or all of the measured properties of target 10. A fully converted target 10d can include sufficient information to render a copy (perfect or imperfect) of displayed target 10b on a display.

Client 100 can generate converted target 10d by assessing only one imaged target 10c. Client 100 can generated converted target 10d by assessing a plurality of imaged targets 10c. Client 100 can generate a plurality of intermediate converted targets 10d, each from a single imaged target 10c taken from a different perspective. Client 100 can average the intermediate converted targets 10d to produce a single final converted target 10d.

Client 100 can recalibrate calibration parameters 105 by comparing converted target 10d to desired target 10a and/or displayed target 10b. Client 100 can recalibrate calibration parameters 105 by comparing a first converted target 10d to a second converted target 10d. The first converted target 10d can originate from a first group of one or more sensors 110. The second converted target 10d can originate from a second, different group of one or more sensors 110.

If host display 151 is assumed to have negligible calibration errors, then differences between (a) the properties of desired target 10a and the properties of converted target 10d and/or (b) the properties of a first converted target 10d and a second converted target 10d can be attributed to calibration parameters 105 of client sensors 110. Therefore, client 100 can recalibrate calibration parameters 105 by (a) comparing the properties of desired target 10a with the properties of converted target 10d and/or (b) comparing the properties of a first converted target 10d with a second converted target 10d.

At least some of the properties of converted target 10d can be absolute geometry independent. For example, the number of feature points in target 10d can be absolute geometry independent. At least some of the properties of converted target 10d can be absolute geometry dependent. For example, the exact surface area of each minor box 501-504 can be absolute geometry dependent.

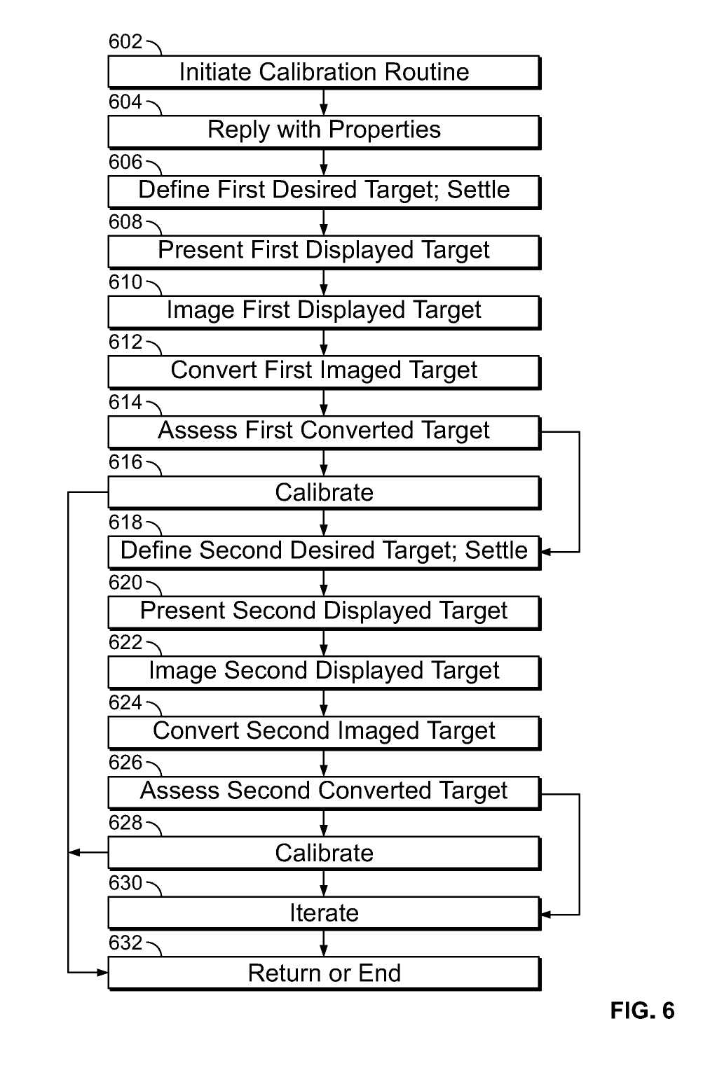

FIG. 6 illustrates an example method of recalibrating client 100 with host 150. The method can represent a calibration routine. Client 100 and host 150 can each be configured to perform their respective portions of the calibration routine.

Prior to block 602, client 100 and host 150 can be in communication (e.g., wirelessly paired). At block 602, a user can cause client 100 to enter a calibration routine. Based thereon, client 100 can command host 150 to reply with properties of host display 151. At block 604, host can reply with the host display properties based on the command. These properties can include any of the above-described host display properties.

At block 606, client 100 can determine a first desired target 10a. Client 100 can determine (e.g., prepare, select, define) first desired target 10a based on the host display properties and/or based on a user-selection of features to be calibrated. Client 100 can determine first desired target 10a by selecting from a predetermined list of options. Client 100 can determine first desired target 10a by organically (i.e., dynamically) generating first desired target 10a according to one or more formulas.

For example, client 100 (or an external database in communication with client 100) can prepare first desired target 10a as a function of: (a) one or more properties of host display, (b) one or more properties of the one or more sensors 105 to be calibrated, and/or (c) an identified calibration error in the one or more sensors 105. Client 100 can define desired target 10a by choosing from a preset list of candidates. Client 100 can store first desired target 10a, including the spatial arrangement, color scheme, and absolute geometry thereof. Therefore, client 100 can settle the first desired target (e.g., store a settled form of first desired target 10a).

During block 606, client 100 can define a species of desired target 10a by selecting a pattern, and then applying a desired complexity to the selected pattern. Complexity can include spatial complexity and/or color complexity.

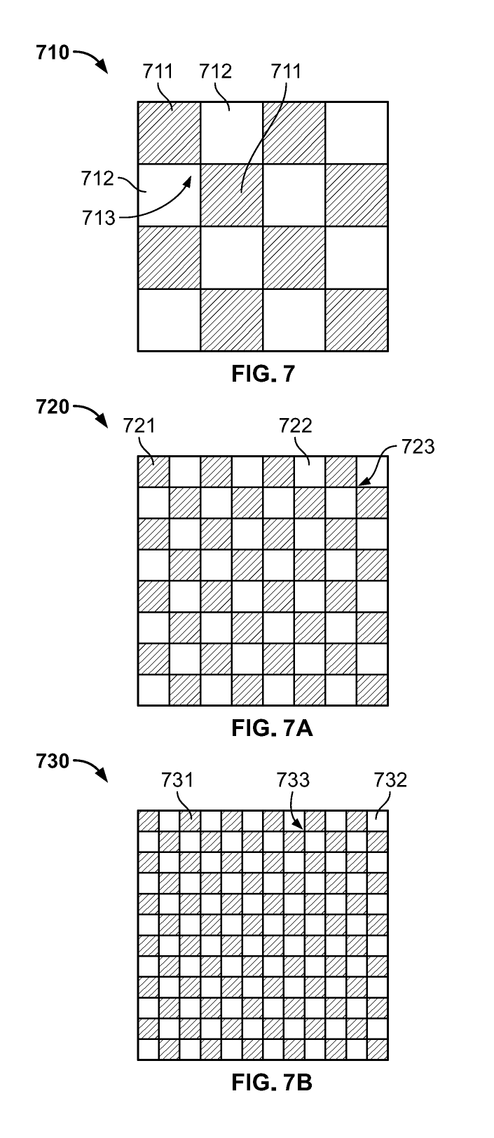

FIGS. 7-7B illustrate targets of varying spatial complexity. Targets 710, 720, 730 have the same repeating spatial pattern consisting of four minor squares arranged to form a major square. Each major square of target 710 includes two first minor squares 711 and two second minor squares 712 defining a first central point 713. Each major square of target 720 includes two third minor squares 721 and two fourth minor squares 722 defining a second central point 723. Each major square of target 730 includes two fifth minor squares 731 and two sixth minor squares 732 defining a third central point 733. All first minor squares 711 can have the same first color. All second minor squares 721 can have the same second color. The same respectively applies for the third-sixth minor squares.

Independent of their absolute sizes, target 730 has more two-dimensional features (e.g., boxes), one-dimensional features (e.g., edges), and zero-dimensional features (e.g., points) than targets 710, 720. Therefore, target 730 has more two-dimensional, one-dimensional, and zero-dimensional features than targets 720 and 710. The same applies to target 720 with respect to target 710. As a consequence, spatial complexity of target 730 exceeds spatial complexity of target 720, which exceeds spatial complexity of target 710.

Color complexity can apply to each feature of a target. Color complexity can be defined by the difference in contrast between fields of color that define a certain feature. In FIG. 7, first minor squares 711 can have a first color and second minor squares 712 can have a second color. If the first color is pure black and the second color is pure white, then the difference in contrast defining each of the spatial features in FIG. 7 is at a maximum and color complexity is at a minimum. As contrast between the first and second colors falls, color complexity increases. For example, if first minor squares 711 were light-gray, blue, or green instead of black, and second minor squares 712 remained white, then the color complexity of each point 713 in target 710 would increase.

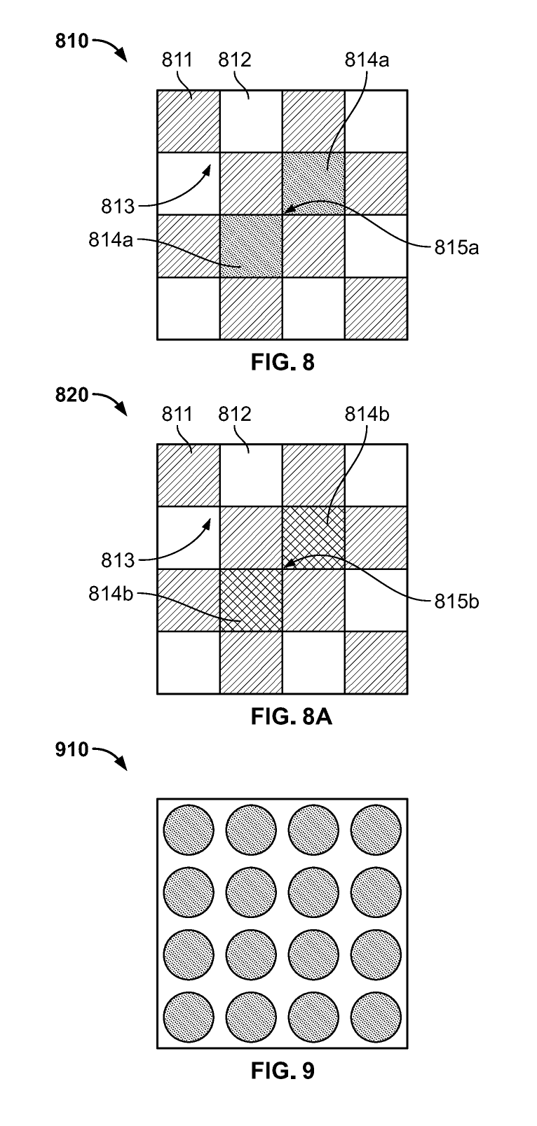

Therefore, comparing FIGS. 8 and 8A with FIG. 7-7B, targets 810 and 820 can have a spatial complexity equal to target 710, and less than targets 720 and 730. Targets 810 and 820 can have an equal color complexity, which is greater than the color complexity of targets 710, 720, and 730.

Targets 710, 720, and 730 are each two-tone. Therefore, the color complexity of each feature point 713, 723, 733 is the same (i.e., color complexity of feature point 713 has an equal color complexity as feature point 723 and 733). Referring to FIGS. 8 and 8A, targets 810 and 820 are each three-tone. Targets 810 and 820 each have the same spatial arrangement as target 710, but a different color scheme.

Across FIGS. 8 and 8A, each first minor square 811 can have the same first color, each second minor square 812 can have the same second color. The two third minor squares 814a in FIG. 8 can have the same third color. The two fourth minor squares 815a in FIG. 8A can have the same fourth color. The minor squares in target 810 define a plurality of first feature points 813 and a second feature point 815a. The minor squares in target 820 define a plurality of first feature points 813 and a third feature point 815b.

Assume that the first color is black, the second color is white, the third color is green, and the fourth color is blue. In this case, the color complexity of second and third feature points 815a and 815b will exceed the color complexity of first feature points 813. Assuming squares 811, 711, 721, and 731 each have the same first color and squares 812, 712, 722, and 732 each have the same second color, at least one feature point in targets 810 and 820 exceeds the color complexity of any feature point in targets 710, 720, and 730.

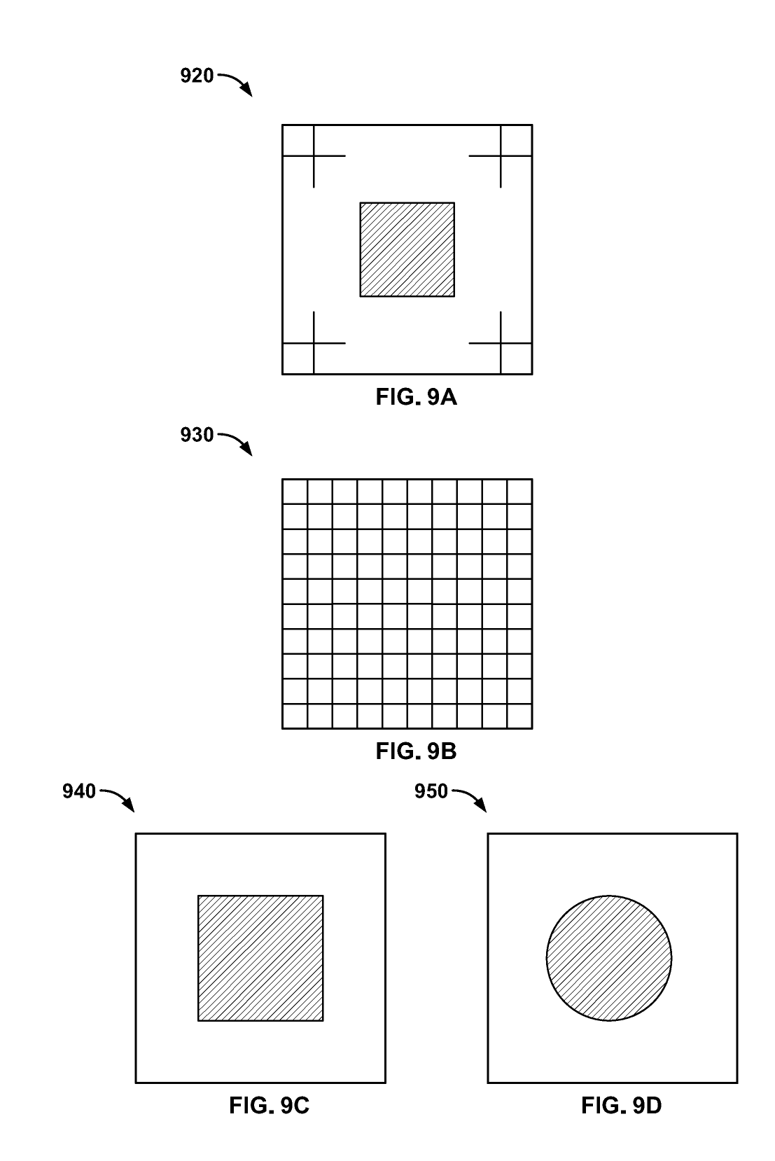

FIGS. 9-9D show targets 910-950, which illustrate other possible spatial arrangements and color schemes. Note that in FIG. 9B, the grid-intersections produce feature points, which when displayed, may have negligible, but still positive, surface area of one pixel.

Returning to block 606, client 100 can select (e.g., determine) the spatial pattern corresponding to targets 7-7B, then select a complexity (spatial and color) for the pattern. The selected spatial complexity can determine the spatial arrangement of the target. The selected color complexity can determine the color scheme of the target.

If a spatial high complexity is selected, client 100 can define target 730 as the first desired target 10a. If a low spatial complexity is selected, client 100 can define target 710 as the first desired target 10a. As stated above, client 100 can originally produce first desired target 10a according to a formula. Client 100 can be configured to organically (i.e., dynamically) prepare first desired target 10a by replicating a selected pattern until a certain number of features (e.g., one-dimensional features) have been generated.

At block 606, client 100 can transmit the first desired target 10a to host 150. Client 100 can do so by sending host 150 a simple ID of first desired target 10a (which host 150 can use to download first desired target 10a from an external database). Client 100 can do so by sending host 150 a vector file for host 150 to render and present. Client 100 can do so by sending host 150 a raster file (e.g., a JPEG) for host 150 to render and present. Client 100 can instruct host 150 to present first desired target 10a in a certain location on host display 151.

At block 608, host 150 can present first desired target 10a as first displayed target 10b. Host 150 can inform client 100 that first displayed target 10b has been presented. In response, client 100 can image first displayed target 10b at block 610. Client 100 can capture a plurality of different images at block 610 from a plurality of different perspectives.

At the beginning of block 602, 604, 606, or 608, client 100 can instruct host 150 to present (i.e., display), a first box. The box can cover a total area of host display 151. Client 100 can image the presented box and assess the image. The assessment can be a defective-pixel check to confirm that host display 151 does not include dead or stuck pixels.

To assess the box image, client 100 can scan for color values in the image of the presented box that are distinct (e.g., sufficiently distinct) from neighboring color values. Client 100 can cause host 150 to transition a color of the presented box through a plurality of predetermined colors (e.g., pure white, red, green, blue, and pure black). Client 100 can perform the above-described defective-pixel check for each of the predetermined colors.

Upon identifying a defective pixel in host display 151, client 100 can terminate the calibration routine. Alternatively, client 100 can quarantine the defective pixel within a predetermined quarantine area. Client 100 can instruct host 150 to only present displayed target 10b in a non-quarantine or safe area. The boundary between the quarantine and safe area can run perpendicular to the major dimension (typically width instead of height) of host display 151. Thus, the boundary can divide host display 151 into a left/right quarantine area and a right/left safe area. The boundary can be spaced from the defective pixel such that the defective pixel is not included in the boundary.

If multiple defective pixels exist, then client 100 can quarantine each defective pixel. If multiple defective pixels exist, client 100 can enforce a second boundary running perpendicular to the original boundary. Client 100 can instruct host 150 to only present displayed target 10b within the safe area defined by the one or more boundaries.

If a quarantine is necessary (and depending on when the defective pixel check is run), client 100 can revise the properties of host display 151 such that the host display surface area, aspect ratio, resolution, etc. is limited to the safe area. Client 100 can therefore re-define first desired target 10a (if the check occurs after block 606) in light of the revised properties of host display 151.

At block 612, and when a sufficient number of images have been captured, client 100 can convert first imaged target 10c into features (e.g., mathematical values such as the number of feature points present, the spacing between each pair of adjacent feature points, and so on). A collection of one or more of these features can represent first converted target 10d. A collection of each feature needed to replicate target 10 can represent a first fully converted target 10d.

During block 612, client 100 can crop each image of client 100 to only include imaged target 10c. Alternatively, client 100 can crop each image of client 100 to depict imaged target 10c and the outer perimeter of host display 151 as a reference. Client 100 can extract the features of imaged target 10c from a single image of host 150 or from multiple images of host 150 from a plurality of different perspectives.

At block 614, client 100 can assess the quality of first imaged target 10c by comparing first converted target 10d to first desired target 10a. For example, client 100 can compare the number of feature points present in first converted target 10d to the number of feature points present in first desired target 10a. As another example, client 100 can compare edge directions in first desired target 10a with edge directions in first converted target 10d.

During the assessment, client 100 can compare some or all of the features that will be referenced during calibration (whether spatial or color) with the features of first desired target 10a. Client 100 can evaluate the comparison. If the comparison yields matching features (e.g., sufficiently similar features), then client 100 can proceed to block 616 and recalibrate based on first imaged target 10c.

At block 614, client 100 can only extract some of the features of imaged target 10c. The extracted features can be aggregate features such as the number of feature points, edges, tones, etc. (e.g., aggregated features). If client 100 proceeds to block 616 after block 614, client 100 can extract additional features (e.g., the coordinates of each feature point, the direction of each edge).

At block 612, client 100 can extract features using any of the above techniques from each of the plurality of images of client 100 (i.e., each of the imaged targets 10c). At block 614, client 100 can individually compare each of the plurality of images (via the converted features) to first desired target 10a. Client 100 can discard unsuitable images (e.g., not rely on the unsuitable images during calibration). For example, if desired target 10a includes one-hundred feature points, client 100 can discard images converted to have more than one-hundred feature points, or less than one-hundred feature points.

If block 614 yields a negative assessment (e.g., an insufficient number of imaged targets 10c are matching/suitable), then client 100 can skip to block 618. Otherwise, client 100 can calibrate at block 616.

During (e.g., at) block 616, client 100 can prepare a fully converted target 10d. Client 100 can prepare a partially converted target 10d with more features than extracted at block 612 and/or assessed at block 614. Client 100 can rely on intrinsic 105a and/or extrinsic 105b parameters to assign coordinates to each aggregated feature. The coordinates can be in the camera coordinate system, the scene coordinate system, or the two-dimensional sensor coordinate system.

During block 616, client 100 can find a difference between one or more features in first converted target 10d and one or more corresponding features in first desired target 10a (e.g., first desired target 10a in a settled state). Client 100 can recalibrate intrinsic 105a and/or extrinsic 105b parameters to converge the features (i.e., minimize the differences between first converted target 10d and first desired target 10a). The recalibration can be iterative.

After each iteration, client 100 can (a) extract updated converted features from imaged target 10c based on the updated calibration parameters, (b) determine whether the updated calibration parameters represent an improvement over the previous calibration parameters (e.g., by querying whether updated calibration parameters improved convergence), (c) adopt the updated calibration parameters if the updated calibration parameters represent an improvement, (d) otherwise revert to the previous calibration parameters, (e) update the calibration parameters 105 in a different way, then (f) return to block (a). Client 100 can iterate until subsequent iterations no longer represent a sufficient improvement.

Blocks 602-616 can be performed in parallel for multiple groups of one or more sensors 110. Thus, at block 616, and for a single sensor 110, client 100 can recalibrate intrinsic and/or extrinsic parameters 105a, 105b of sensor 110 by converging converted target 10d with desired target 10a (e.g., desired settled target 10a). Alternatively or in addition, client 100 can recalibrate intrinsic and/or extrinsic parameters 105a, 105b by converging a first converted target 10d originating from a first group of one or more sensors 110 with a second converted target 10d originating from a second group of one or more sensors 110.

If the target calibration parameters 105 (i.e., parameters to be recalibrated) have been sufficiently optimized, client 100 can jump to block 632. Otherwise, client 100 can proceed to block 618. There, client 100 can assess sufficiency of optimization with one or more functions (e.g., a least-squares function).

Client 100 can assess sufficiency of optimization with a function that accounts for difference in spatial position between a plurality of features of first desired target 10a and a corresponding plurality of features in first converted target 10d. For example, client 100 can find a magnitude of displacement, for each feature point in target 10, between first desired target 10a and first converted target 10d. Client 100 can square each magnitude, sum each square, then take the square root of the sum. Client 100 can assess sufficiency by comparing the square root of the sum with a predetermined value (e.g., if the sum is less than three, then recalibration is sufficient).

At block 618, client 100 can determine a second desired target 10a. Client 100 can determine the second desired target 10a based on the first desired target 10a. For example, client 100 can determine a second desired target 10a that with the spatial pattern of first desired target 10a but with a new spatial and/or color complexity. Client 100 can define the new spatial and/or color complexity based on (a) the calibration results of block 616 and/or (b) whether client 100 skipped block 616. Client 100 can determine the second desired target by, for example, dynamically generating the second desired target 10a or selecting the second desired target 10a from a predetermined list.

If recalibration at block 616 was sufficient, client 100 can increase the spatial and/or color complexity of second desired target 10a with respect to first desired target 10a. For example, client 100 can transition from target 710 to target 720, 730, 810, or 820. Client 100 can increase complexity based on how the degree of recalibration success at block 616. If the success was high, client 100 can transition from target 710 to target 730. If the success was moderate, client 100 can transition from target 710 to target 720.

As discussed above, client 100 can evaluate success based on the degree of optimization achieved during block 616 (e.g., how close one or more features of settled desired target 10a matched corresponding features of converted target 10d). Client 100 can define second desired target 10a to have the same size/surface area as first desired target 10a.

When determining second desired target 10a, client 100 can modify only one of spatial complexity and color complexity. For example, client 100 can either (a) retain the spatial arrangement of target 710, but increase color complexity by reducing contrast between first squares 711 and second squares 712 or (b) retain the color complexity of target 710, but increase the spatial complexity by adding more feature points (e.g., transitioning to target 720).

If recalibration at block 616 was insufficient or client 100 skipped block 616, client 100 can decrease the spatial and/or color complexity of second desired target 10a with respect to first desired target 10a. For example, client 100 can transition from target 730 to target 720 or target 720 based on the degree of insufficiency at block 616. As another example, client 100 can retain the spatial arrangement of target 730, but increase the contrast between squares 731 and 732 (e.g., by making squares 732 brighter and/or squares 731 darker).

During block 718, client 100 can settle second desired target 10a based on the already received host display properties. After block 718, client 100 can proceed through blocks 620-628, which can mirror blocks 608-616. Any of the above description related to blocks 602-616 can apply to blocks 618-628.

At block 630, client 100 can repeat blocks 616-626 for a third desired target 10a. Therefore: (a) if recalibration at block 616 was unsuccessful (or block 616 was skipped) and recalibration at block 628 was successful, then third desired target 10a can have a complexity between first and second desired target 10a; (b) if recalibration at block 616 was successful and recalibration at block 628 was successful, then third desired target 10a can have a complexity greater than first and second desired targets 10a; (c) if recalibration at blocks 616 and 628 was unsuccessful/skipped, then third desired target 10a can have a complexity less than first and second desired targets 10a; (d) if recalibration at block 616 was successful and recalibration at block 628 was unsuccessful (or block 628 was skipped), then third desired target 10a can have a complexity between first and second desired target 10a.

Client 100 can repeat block 630 for a fourth desired target 10a, a fifth desired target 10a, etc. Client 100 can be configured to only modify one of spatial complexity and color complexity between iterations.

At block 632, client 100 can end the calibration routine or return to block 608. If returning to block 608, client 100 can calibrate a new sensor, different parameters for the same sensor, or a different grouping of sensors. Client 100 can proceed to block 632 after a predetermined number of iterations (e.g., five), in response to a user command, and/or upon achieving a sufficient level of recalibration for the target calibration parameters.

Client 100 can apply the recalibration routine of FIG. 6 to improve the extrinsic parameters 105b spatially linking a first sensor group including projector 115 and fourth camera 114 with a second sensor group including one or more cameras 111-113. In this example, projector 115 is an infrared dot projector, fourth camera 114 is an infrared camera, cameras 111-113 are full-color cameras.

It may be easier for a full-color camera to resolve feature points defined at the intersection of black and white squares (e.g., feature points 713, 723, 733 when targets 710, 720, 730 are at a minimum color complexity). However, it may be easier for fourth camera 114 to resolve infrared dots projected onto a display with a higher color complexity (e.g., when targets 710, 720, 730 are at a high color complexity such as when the squares 711, 721, 731 are light gray and squares 712, 722, 732 are white).

Therefore, at block 606, client 100 can define a first desired target 10a (e.g., target 710 with a medium color complexity). At block 610, client 100 can image first desired target 10a with fourth camera 114 (after emitting the dots) and image first desired target 10a with the full-color camera(s).

At blocks 612 and 614, client 100 can determine whether the full-color camera(s) in the second group resolved the correct number of feature points in first converted target(s) 10d. At blocks 612 and 614, client 100 can determine whether the fourth camera resolved the correct number of dots. Because fourth camera may be unable to determine the boundaries of host display 151, client 100 can determine whether the dot density is uniform (e.g., sufficiently constant) over a two-dimensional area corresponding to host display 151.

Client 100 can determine the boundaries applying texture to the infrared image based on extrinsic calibration 105b between fourth camera 114 and a non-calibrated full-color camera. Alternatively or in addition, client 100 can determine the boundaries of host display 151 based on background infrared light emitted by host display 151.

If, at block 614, an insufficient number of dots are detected (e.g., a non-uniform dot density was detected in the plane of host display 151), client 100 can proceed to block 618 and increase color complexity by reducing contrast. Client 100 can retain or reduce spatial complexity. If, at block 614, an insufficient number of feature points are detected, client 100 can proceed to block 618 and reduce color complexity by increasing contrast. Client can iterate through blocks 618-630 until (a) a displayed target 10b suitable for both sensor groups is identified or (b) no color scheme of target 10 is identified after a predetermined number of iterations. If (b) occurs, client 100 can reduce spatial complexity and repeat.

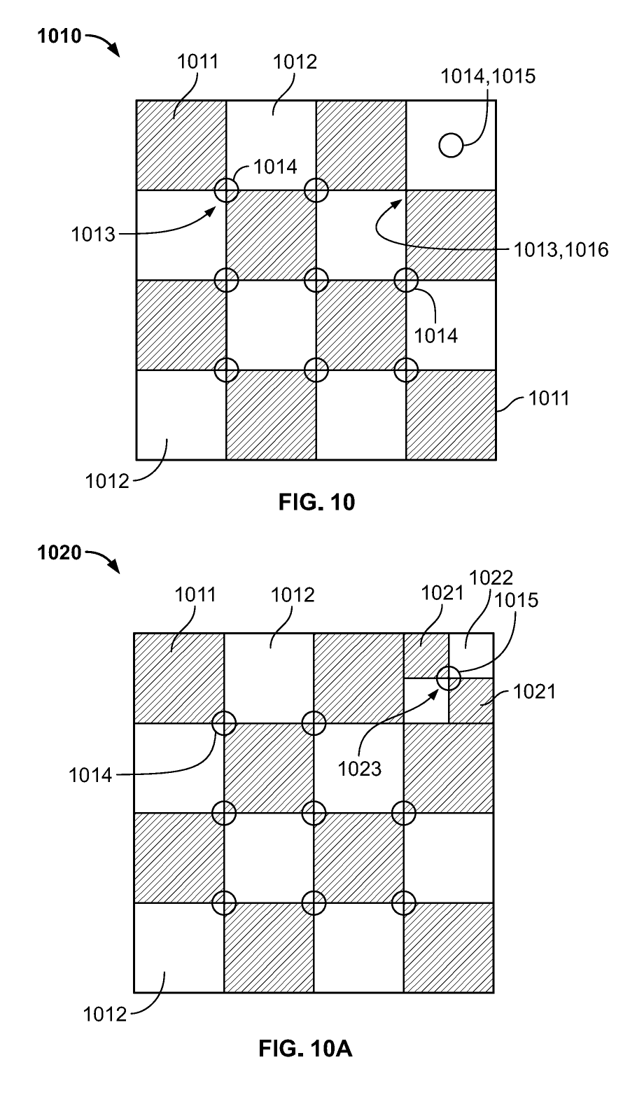

FIG. 10 shows a first converted target 1010, 10d with first squares 1011, second squares 1012, feature points 1013 and infrared dots 1014. First converted target 1010 can therefore represent conversions of two different imaged targets 10c combined via extrinsic parameters 105b (e.g., one converted imaged 10c captured with fourth camera based on projector 115 and one imaged target 10c generated with the full-color camera(s)). In FIG. 10, feature point 1016 is misaligned with dot 1015.

At block 614, client 100 can assess whether first imaged that first imaged target 1010 includes the correct aggregate number of feature points 113. Client 100 can assess whether each feature point 113 in first converted target 1010 is centered under a dot 114. Alternatively, client 100 can assess whether each dot 114 in first converted target 1010 is centered under a feature point 113.

If the assessment of block 614 fails, then client 100 can iterate by skipping to block 618. There, client 100 can increase spatial complexity (while retaining color complexity) to add a feature point 1023 beneath dot 1015 by inserting squares 1021, 1022. Although not shown, client 100 can remove feature point 1016 or simply decline to rely on feature point 1016 during recalibration.

At block 626, client 100 can assess second converted target 1020. If the correspondence between dots 1014 and feature points 1013 has decreased, client 100 can assume that client 100 has moved and skip to block 632 or block 608. If correspondence has improved (e.g., correspondence has improved for each feature point 113, except for removed/not relied on feature points 1016), client 100 can calibrate extrinsic parameters 105b of the first and/or second group. Client 100 can recalibrate without relying on any feature points 113 that are not below a dot 1014 (e.g., feature point 1016).

Client 100 can continue the cycle of (a) increasing spatial complexity by adding feature points underneath dots, (b) recalibrating extrinsic parameters 105b, and (c) adjusting color complexity (if necessary), until sufficient correspondence between dots 1014 and considered feature points 1013 has been achieved.

Client 100 and/or host 150 can be a smartphone, a tablet, a digital camera, or a laptop. Client 100 and/or host 150 can be an Android® device, an Apple® device (e.g., an iPhone®, an iPad®, or a Macbook®), or Microsoft® device (e.g., a Surface Book®, a Windows® phone, or Windows® desktop).

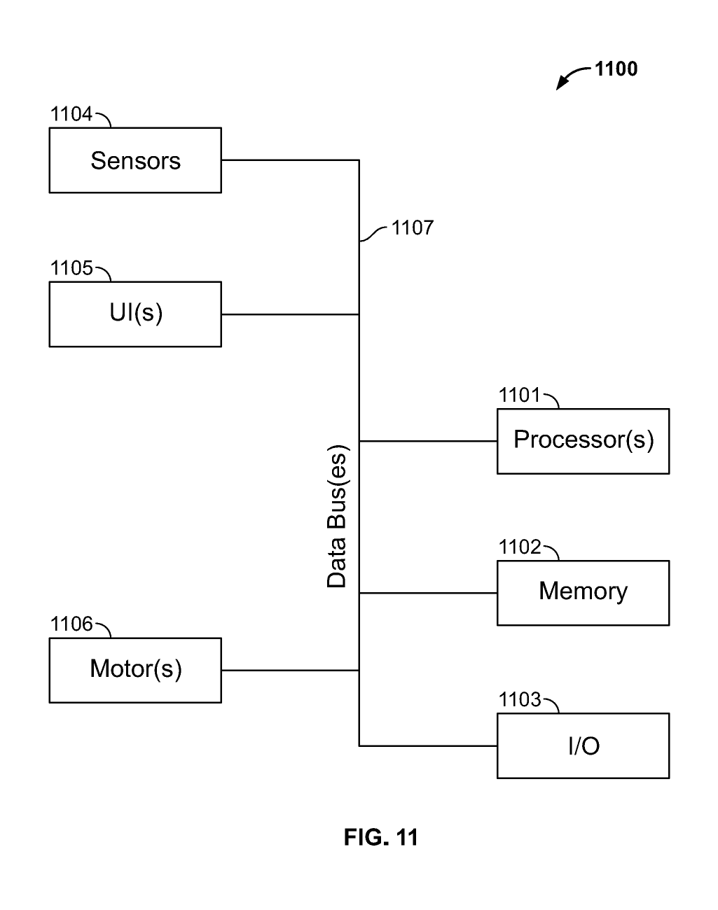

As schematically shown in FIG. 11, client 100 and/or host 150 can include a processing system 1100. Processing system 1100 can differ between client 100 and host 150. Processing system 1100 can include one or more processors 1101, memory 1102, one or more input/output devices 1103, one or more sensors 1104, one or more user interfaces 1105, one or more motors/actuators 1106, and one or more data buses 1107.

Processors 1101 can include one or more distinct processors, each having one or more cores. Each of the distinct processors can have the same or different structure. Processors 1101 can include one or more central processing units (CPUs), one or more graphics processing units (GPUs), circuitry (e.g., application specific integrated circuits (ASICs)), digital signal processors (DSPs), and the like. Processors 1101 can be mounted on a common substrate or to different substrates.

Processors 1101 are configured to perform a certain function, method, or operation at least when one of the one or more of the distinct processors is capable of executing code, stored on memory 1102 embodying the function, method, or operation. Client processors 1101 and/or host processors 1101 can be configured to perform any and all functions, methods, and operations disclosed herein.

For example, when the present disclosure states that processing system 1100 can perform task “X”, such a statement should be understood to disclose that processing system 1100 can be configured to perform task “X”. Processing system 1100 is configured to perform a function, method, or operation at least when processors 1101 are configured to do the same.

Memory 1102 can include volatile memory, non-volatile memory, and any other medium capable of storing data. Each of the volatile memory, non-volatile memory, and any other type of memory can include multiple different memory devices, located at a multiple distinct locations and each having a different structure.

Examples of memory 1102 include a non-transitory computer-readable media such as RAM, ROM, flash memory, EEPROM, any kind of optical storage disk such as a DVD, a Blu-Ray® disc, magnetic storage, holographic storage, an HDD, an SSD, any medium that can be used to store program code in the form of instructions or data structures, and the like. Any and all of the methods, functions, and operations described in the present application can be fully embodied in the form of tangible and/or non-transitory machine readable code saved in memory 1102.

Input-output devices 1103 can include any component for trafficking data such as ports and telematics. Input-output devices 1103 can enable wired communication via USB®, DisplayPort®, HDMI®, Ethernet, and the like. Input-output devices 1103 can enable electronic, optical, magnetic, and holographic, communication with suitable memory 1103. Input-output devices can enable wireless communication via WiFi®, Bluetooth®, cellular (e.g., LTE®, CDMA®, GSM®, WiMax®, NFU)), GPS, and the like.

Sensors 1104 can capture physical measurements of environment and report the same to processors 1101. Sensors 1104 can include sensors 110. Any sensors 1104 can be independently activated and deactivated.

User interface 1105 can enable user interaction with imaging system 110. User interface 1105 can include displays (e.g., LED touchscreens (e.g., OLED touchscreens)), physical buttons, speakers, microphones, keyboards, and the like. User interface 1105 can include display 101, 151.

Motors/actuators 1106 can enable processor 1101 to control mechanical or chemical forces. If any camera includes auto-focus, motors/actuators 1106 can move a lens along its optical axis to provide auto-focus.

Data bus 1107 can traffic data between the components of processing system 1100. Data bus 1107 can include conductive paths printed on, or otherwise applied to, a substrate (e.g., conductive paths on a logic board), SATA cables, coaxial cables, USB® cables, Ethernet cables, copper wires, and the like. Data bus 1107 can consist of logic board conductive paths Data bus 1107 can include a wireless communication pathway. Data bus 1107 can include a series of different wires 1107 (e.g., USB® cables) through which different components of processing system 1100 are connected.

1. A method for adjusting a calibration parameter of an image capture device, comprising, via a client comprising one or more client processors:
determining a first desired target;
instructing a host comprising one or more host processors and a host display to present the first desired target on the host display;
imaging the first displayed target using a first camera of an image capture device to obtain one or more first images of the first displayed target;
assessing the one or more first images of the first displayed target;
determining a second desired target based on the assessment of the first images, the second desired target having a different complexity from the first desired target;
instructing the host to present the second desired target on the host display;
imaging the second displayed target using the first camera of the image capture device to obtain one or more second images of the second displayed target;
adjusting a sensor calibration parameter or camera calibration parameter applied to images captured by a second camera of the image capture device based on the one or more second images of the second displayed target and the second desired target.

2. The method of claim 1, comprising:
connecting with the host;
establishing a resolution and surface area of the host display;
determining the first desired target based on the established resolution and the established surface area.

3. The method of claim 2, wherein determining the first desired target comprises dynamically generating the first desired target based on the established resolution and the established surface area.

4. The method of claim 1, comprising prior to adjusting the calibration parameter based on the one or more second images and the second desired target:
assessing the one or more second images of the second displayed target.

5. The method of claim 1, comprising: determining the second desired target based on assessing that the one or more first images of the first displayed target are unsuitable for adjusting the calibration parameter.

6. The method of claim 5, comprising: determining the second desired target based on the first desired target.

7. The method of claim 6, wherein the first desired target comprises a first spatial arrangement and a first color scheme and the second desired target comprises a second spatial arrangement and a second color scheme;
the first spatial arrangement being equivalent to the second spatial arrangement;
the first color scheme being different than the second color scheme.

8. The method of claim 7, wherein the first desired target comprises a first maximum contrast and the second desired target comprises a second maximum contrast;
the first maximum contrast exceeding the second maximum contrast.

9. The method of claim 1, wherein assessing the one or more first images of the first displayed target comprises:
identifying a plurality of first features in the one or more first images;
counting the number of identified first features;
comparing the first count of the number of identified first features to a first predetermined count;
finding that the first predetermined count exceeds the first count.

10. The method of claim 9, comprising deriving the first predetermined count from the first desired target.

11. The method of claim 9, comprising, prior to adjusting the calibration parameter based on the one or more second images and the second desired target, assessing the one or more second images of the second displayed target by:
identifying a plurality of second features in the one or more second images;
counting the number of identified second features;
comparing the second count of the number of identified second features to a second predetermined count;
finding that the second predetermined count equals the second count.

12. The method of claim 1,
wherein the first camera of the image capturing device is an image sensor comprising a plurality of sensor pixels, each of the sensor pixels comprising a photodiode, comprising:
assessing the one or more first images comprising: deriving a metric from the one or more first images;
adjusting the calibration parameter based on the one or more second images comprising: deriving a metric from the one or more second images; and
the calibration parameter being an intrinsic or extrinsic calibration parameter for the second camera.

13. The method of claim 1, wherein the one or more client processors are configured to perform the method prior to determining the first desired target.

14. A client processing system comprising one or more client processors for adjusting a calibration parameter of an image capture device, the one or more client processors configured to:
determine a first desired target;
instruct a host comprising one or more host processors and a host display to present the first desired target on the host display;
image the first displayed target using a first camera of an image capture device to obtain one or more first images of the first displayed target;
assess the one or more first images of the first displayed target;
determine a second desired target based on the assessment of the first images, the second desired target having a different complexity from the first desired target;
instruct the host to present the second desired target on the host display;
image the second displayed target using the first camera of the image capture device to obtain one or more second images of the second displayed target;
adjust a sensor calibration parameter or camera calibration parameter of applied to images captured by a second camera of the image capture device based on the one or more second images of the second displayed target and the second desired target.

15. The client processing system of claim 14, wherein the one or more client processors are configured to:
cause the client processing system to connect with the host;
determine the first desired target based on a resolution and surface area of the host display.

16. The client processing system of claim 15, wherein the one or more client processors are configured to dynamically generate the first desired target based on the established resolution and the established surface area.

17. The client processing system of claim 14, wherein the one or more client processors are configured to:
determine the second desired target based on assessing that the one or more first images of the first displayed target are unsuitable for adjusting the calibration parameter;
determine the second desired target based on the first desired target.

18. The client processing system of claim 14, wherein the first desired target comprises a first spatial arrangement and a first color scheme and the second desired target comprises a second spatial arrangement and a second color scheme;
the first spatial arrangement being equivalent to the second spatial arrangement;
the first color scheme being different than the second color scheme.

19. The client processing system of claim 14, wherein the one or more processors are configured to assess the one or more first images of the first displayed target by:
identifying a plurality of first features in the one or more first images;
counting the number of identified first features;
comparing the first count of the number of identified first features to a first predetermined count;
finding that the first predetermined count exceeds the first count.

20. The client processing system of claim 19, wherein the one or more processors are configured to, prior to adjusting the calibration parameter based on the one or more second images and the second desired target:
assess the one or more second images of the second displayed target by:
identifying a plurality of second features in the one or more second images;
counting the number of identified second features;
comparing the second count of the number of identified second features to a second predetermined count;
finding that the second predetermined count equals the second count.

21. The client processing system of claim 14, wherein the first camera of the image capturing device is an image sensor comprising a plurality of sensor pixels, the one or more client processors being configured to:
image the first displayed target and the second displayed target with the image sensor;
assess the one or more first images by deriving a metric from the one or more first images;
adjust the calibration parameter based on the one or more second images by deriving a metric from the one or more second images;
the calibration parameter being an intrinsic or extrinsic calibration parameter for the second camera.

22. A non-transitory computer readable storage medium comprising program code, which, when executed by one or more client processors, causes the one or more client processors to adjust a calibration parameter of an image capture device, including performing the following operations:
determining a first desired target;
instructing a host comprising one or more host processors and a host display to present the first desired target on the host display;
imaging the first displayed target using a first camera of an image capture device to obtain one or more first images of the first displayed target;
assessing the one or more first images of the first displayed target;
determining a second desired target based on the assessment of the first images, the second desired target having a different complexity from the first desired target;
instructing the host to present the second desired target on the host display;
imaging the second displayed target using the first camera of the image capture device to obtain one or more second images of the second displayed target;
adjusting a sensor calibration parameter or camera calibration parameter applied to images captured by a second camera of the image capture device based on the one or more second images of the second displayed target and the second desired target.

23. The method of claim 1, comprising:
adjusting a second sensor calibration parameter or camera calibration parameter applied to images captured by the first camera of the image capture device based on the one or more second images of the second displayed target and the second desired target.

24. The client processing system of claim 14, wherein the one or more client processors are configured to:
adjust a second sensor calibration parameter or camera calibration parameter applied to images captured by the first camera of the image capture device based on the one or more second images of the second displayed target and the second desired target.
